(19) United States
(12) Patent Application Publication
(10) Pub. No.: US 2023/0015527 A1
(43) Pub. Date: Jan. 19, 2023

(54) Electric Processing Tool Having an Energy Supply Device

(71) Applicant: Robert Bosch GmbH, Stuttgart (DE)

(72) Inventor: Philipp Zipf, Stuttgart (DE)

(21) Appl. No.: 17/757,589

(22) PCT Filed: Nov. 13, 2020
(86) PCT No.: PCT/EP2020/082035

§ 371 Date: Jun. 17, 2022

(30) Foreign Application Priority Data
Dec. 20, 2019 (DE) 10 2019 220 475.9

(51) Int. Cl. H02J 7/00

(52) U.S. Cl. CPC H02J 7/00304

(57) ABSTRACT

An electric processing tool includes an energy supply device and an open-loop or closed-loop control unit. The energy supply device includes at least two energy sources which are interconnected, each in a series circuit with an electronic component for applying the logical operator “OR” to the individual current of the electronic component in question, to form a common star point, such that a resulting total current for supplying the electric processing tool results. At least a subset of the energy sources, in particular each energy source, is assigned a current-measuring unit for measuring the individual current of the energy source in question. The open-loop or closed-loop control unit is configured to adapt the total current to the measured individual currents.

### DESCRIPTION

The invention relates to an electric processing tool having an energy supply device in accordance with the generic type of independent claim 1.

### PRIOR ART

Electric processing tools are offered for sale in very different power classes depending on their intended use. Thus, for example, there are machine hand tools operated by rechargeable batteries in lower power classes which are operated on 10.8 V (nominally often also referred to as 12 V) or 14.4 V, whereas in the middle to higher power classes predominantly tools in the 18 V, 36 V, 54 V or else 72 V voltage classes are used. The voltage values in this case result from the interconnection (in parallel or in series) of the rechargeable battery cells used. Preferably, the rechargeable battery cells are in this case in the form of lithium-based rechargeable battery cells, for example Li-ion, Li—Po, Li-metal or the like, with a cell voltage of 3.6 V, wherein a rechargeable battery cell is generally a cylindrical round cell, whose cell terminals are arranged at the ends of the cylinder shape. The invention below is not, however, dependent on the type and design of the rechargeable battery cells used, but can be applied to any desired energy sources, for example, in addition to round cells, also pouch cells or the like. Likewise, a grid power supply of, for example, 120 V or 230 V can be used as the energy source.

In order to ensure, in particular in industrial applications, as long operating times and as short pause times as possible, in the case of many processing tools operated by rechargeable batteries interchangeable rechargeable batteries or interchangeable rechargeable battery packs have become established as energy source. They are detachably connected to one another in a force-fitting and/or form-fitting manner via corresponding interfaces at the interchangeable rechargeable battery packs and the processing tools operated by rechargeable batteries. A “detachable connection” is intended in particular to mean a connection which can be detached and produced without the use of tools, i.e. by hand.

In the meantime it is conventional to use in particular electric tools with very high power requirements with a plurality of interchangeable rechargeable battery packs in series or parallel operation. In series operation, for example, the use of two 18 V interchangeable rechargeable battery packs results in a supply voltage of 36 V. In parallel operation, the power is correspondingly increased by an increase in the maximum producible total current. A particular advantage of the use of a plurality of interchangeable rechargeable battery packs in such a processing tool operated by a rechargeable battery is the maintenance of the compatibility with already existing electric tools of lower power classes which are operated by rechargeable batteries and which are only operated with one interchangeable rechargeable battery pack. There are also already electric tools which can be operated both with a grid power supply and with a rechargeable battery power supply.

Both during parallel operation of a plurality of interchangeable rechargeable battery packs and during mixed operation from the grid power supply and rechargeable battery power supply of an electric processing tool, so-called power ORing can be used. DE 10 2013 221 113 A1 discloses, for example, performing electrical charge balancing between the energy sources, in particular between the energy stores, by means of diodes. In this case, an electrical energy supply device has at least two energy stores, which are interconnected in series with in each case at least one diode so as to form a star point. In the case of unequal states of charge of the energy stores, matching of the states of charge of the energy stores can be performed by means of leakage currents of the diodes. Instead of the diodes, alternatively also MOSFETs can be used in conjunction with a so-called “Ideal Diode Controller” (for example LTC4357, ZXGD3112N7, LM5051).

In a system with power ORing, the summation current from a plurality of energy sources can have in principle a higher value than the current of an individual energy source. In this case, however, there is the risk that the power limits of the individual energy sources are exceeded. Therefore, provision is generally made for the summation current to be limited to the lowest individual current of the energy sources.

The object of the invention consists in providing an electric processing tool which ensures safe operation of the individual energy sources while maximizing the summation current which can be produced by the energy sources connected to the electric processing tool.

### ADVANTAGES OF THE INVENTION

The invention relates to an electric processing tool having an energy supply device and having an open-loop or closed-loop control unit, wherein the energy supply device has at least two energy sources, which are each interconnected in a series circuit with an electronic component for ORing their individual currents so as to form a common star point in such a way that a resultant summation current results for supplying power to the electric processing tool. In order to achieve the set object, provision is made for a current measurement unit for measuring the individual currents of the energy sources to be assigned to at least one subset of the energy sources, in particular to each energy source, wherein the open-loop or closed-loop control unit matches the summation current to the measured individual currents. With particular advantage, therefore, the individual energy sources can be analyzed precisely on the basis of the detected current measured values in order to ensure that, given a maximum possible summation current, the individual energy sources are not operated outside their respectively permitted range. As a result, in comparison with the solutions from the prior art, an energy supply device with a higher output current and a higher maximum power can be achieved.

A possible current measurement unit is, for example, a shunt resistor, a Hall sensor or the like. The open-loop or closed-loop control unit can be in the form of a microprocessor, a DSP, an ASIC or the like and can evaluate, using the information provided by the current measurement units and the knowledge of the type of energy source and its permitted individual currents, whether the summation current needs to be reduced or can be increased.

In the context of the invention, electric processing tools are intended to be understood to mean, for example, electric tools for processing workpieces by means of an electrically driven tool insert. In this case, the electric tool can be in the form of both an electric hand tool and a stationary electric machine tool. Typical electric tools are in this connection handheld drills or drill presses, screwdrivers, hammer drills, rotary hammer drills, planes, angle grinders, sanders, polishing machines, circular saws, table saws, miter saws and jigsaws or the like. However, possible electric processing tools are also gardening tools such as lawnmowers, lawn trimmers, pruning saws or the like. Furthermore, the invention can also be applied to domestic appliances such as vacuum cleaners, mixers, etc.

The rechargeable battery voltage of an interchangeable rechargeable battery pack is generally a multiple of the voltage of an individual rechargeable battery cell and results from the interconnection (in parallel or in series) of the individual rechargeable battery cells. A rechargeable battery cell is typically in the form of a galvanic cell which has a design in which one cell terminal comes to lie at one end and a further cell terminal comes to lie at an opposite end. In particular, the rechargeable battery cell has a positive cell terminal at one end and a negative cell terminal at an opposite end. Preferably, the rechargeable battery cells are in the form of lithium-based rechargeable battery cells, for example Li-ion, Li—Po, Li-metal or the like. However, the invention can also be applied to interchangeable rechargeable battery packs having Ni—Cd, Ni—MH cells or other suitable cell types. In the case of conventional Li-ion rechargeable battery cells having a cell voltage of 3.6 V, voltage classes of 3.6 V, 7.2 V, 10.8 V, 14.4 V, 18 V, 36 V etc. result, by way of example. Preferably, a rechargeable battery cell is in the form of an at least substantially cylindrical round cell, wherein the cell terminals are arranged at the ends of the cylinder shape. However, the invention is not dependent of the type and design of the rechargeable battery cells used, but rather can be applied to any desired interchangeable rechargeable battery packs and rechargeable battery cells, for example, in addition to round cells, also pouch cells or the like. Likewise, they can be applied to non-rechargeable batteries and to a grid power supply supplementing the rechargeable battery or battery power supply.

It will further be mentioned that the configuration of the electromechanical interfaces of processing tools operated using rechargeable batteries and the associated receptacles for the connection, which is detachable in a force-fitting and/or form-fitting manner, of the interchangeable rechargeable battery packs for the different voltage classes is not intended to be the subject matter of this invention. A person skilled in the art will select a suitable embodiment for the interface depending on the power or voltage class of the electric processing tool and/or the interchangeable rechargeable battery packs. The embodiments shown in the exemplary embodiments should therefore be understood as being merely exemplary.

In a further configuration of the invention, the energy supply device has, for each energy source, a voltmeter for measuring the voltage provided by the respective energy source. In addition, provision can be made for the energy supply device to have a voltmeter for measuring a supply voltage at the star point. Advantageously, a plausibility check in respect of the measured current values can be performed by means of the measured voltage values.

In a further embodiment of the invention, provision is made for the energy supply device to have a current measurement unit for measuring the summation current at the star point. The measured summation current can also be used advantageously for performing a plausibility check in respect of the measured individual current values of the energy sources.

Alternatively or in addition, the energy supply device can have a temperature measurement device for measuring a temperature of the energy supply device. On the basis of the measured temperature, it is possible to limit the summation current in order to avoid overheating of the energy supply device or individual components.

Further protection from overloading of the energy supply device according to the invention can be provided by protective circuits for protection from an overvoltage and/or an overcurrent.

### EXEMPLARY EMBODIMENTS

### Drawings

The invention will be explained by way of example below with reference to FIGS. 1 to 3, wherein identical reference symbols in the figures indicate identical parts having an identical function.

In the drawings:

FIG. 1 shows a block circuit diagram of a first exemplary embodiment of an energy supply device according to the invention for an electric processing tool,

FIG. 2 shows a block circuit diagram of a second exemplary embodiment of the energy supply device according to the invention for an electric processing tool, and

FIG. 3 shows a block circuit diagram of a third exemplary embodiment of the energy supply device according to the invention for an electric processing tool.

### DESCRIPTION OF THE EXEMPLARY EMBODIMENTS

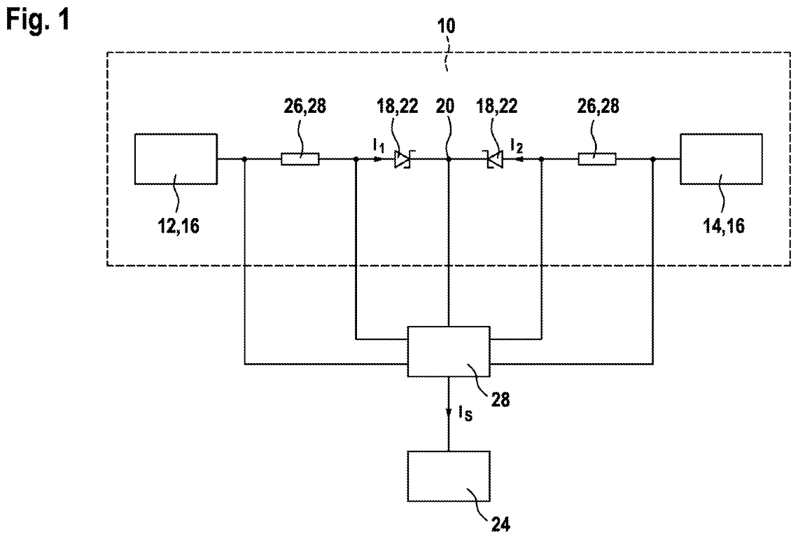

FIG. 1 shows a block circuit diagram of a first exemplary embodiment of an energy supply device 10 according to the invention of an electric processing tool (not illustrated in any more detail). As has already been described at the outset, in the context of the invention, an electric processing tool should be understood to mean, for example, an electric tool for processing workpieces by means of an electrically driven tool insert. In this case, the electric tool can be in the form of both an electric hand tool operated by a rechargeable battery and a stationary electric machine tool, which is supplied power by means of interchangeable rechargeable battery packs and possibly additionally by means of line current. Typical electric tools are in this connection handheld drills or drill presses, screwdrivers, hammer drills, rotary hammer drills, planes, angle grinders, sanders, polishing machines, circular saws, table saws, miter saws and jigsaws or the like. However, possible electric processing tools are also gardening tools such as lawnmowers, lawn trimmers, pruning saws or the like. Furthermore, the invention can also be applied to domestic appliances such as vacuum cleaners, mixers, etc.

The energy supply device 10 is in the form of a power ORing system having a first energy source 12 and a second energy source 14. The two energy sources 12 and 14 can be in the form of interchangeable rechargeable battery packs or interchangeable rechargeable batteries 16 of the electric processing tool. It is likewise conceivable that the first energy source 12 is an interchangeable rechargeable battery pack 16 and the second energy source 14 is the power pack of a grid power supply. Depending on the power class of the electric processing tool, very different interchangeable rechargeable battery packs or interchangeable rechargeable batteries 16 and energy sources 12, 14 can be used. Since the configuration of such interchangeable rechargeable battery packs or interchangeable rechargeable batteries 16 and energy sources 12, 14 is known to a person skilled in the art, no further details will be set forth in this regard below. Also, the number of energy sources can vary. The invention is therefore not restricted to two energy sources 12, 14.

The two energy sources 12, 14 are each interconnected in series with an electronic component 18 for ORing their individual currents I₁ and I₂ so as to form a common star point 20. The electronic components 18 can be in the form of diodes 22, for example, whose cathodes are at the same potential at the star point 20. The diodes 22 can be in the form of Schottky diodes, for example, which have a relatively high leakage current of up to approximately 100 mA in the reverse direction. However, in principle other types of diodes are also conceivable which are suitable for ORing the individual currents. Instead of the diodes 22, however, it is also conceivable to use MOSFETs having an “Ideal Diode Controller” IC, such as, for example, an LTC4357, ZXGD3112N7, LM5051 or the like.

The power ORing of the first energy source 12 with its individual current I₁ and the second energy source 14 with its individual current I₂ results in a resultant summation current I_{S} downstream of the star point 20 in the direction of current flow for supplying power to the electric processing tool or to a consumer 24 contained therein which may be, for example, in the form of an electric motor and/or an open-loop or closed-loop control loop for the electric motor. Virtually anything which significantly influences the power requirement of the electric processing tool is possible as the consumer 24 of the electric processing tool.

In accordance with the invention, provision is made for a current measurement unit 26 for measuring the individual currents I₁, I₂ of the energy sources 12, 14 to be assigned to each energy source 12, 14. The current measurement unit 26 can be in the form of, for example, a shunt resistor 28, which is connected in series with the energy source 12, 14 and the electronic component 18 for ORing the individual currents I₁, I₂. However, a Hall sensor or the like is also conceivable for the current measurement. The current measurement units 26 are connected to an open-loop or closed-loop control unit 30 of the energy supply device 10. The open-loop or closed-loop control unit 30 matches the summation current I_{S} to the measured individual currents I₁, I₂ in such a way that the energy sources 12, 14 can always be operated in their respectively permissible operating range.

The information on the maximum permissible summation current I_{S} is provided to the consumer 24 by the open-loop or closed-loop control unit 30, for example, via a bus system, an analog voltage signal, a frequency-modulated signal or the like. The consumer 24 of the electric processing tool can then adapt the power consumption in such a way that, limited by the internal resistances and supply voltages of the individual energy sources 12, 14, in each case one individual current I₁, I₂ can be drawn from the energy sources 12, 14 which is within the respectively permitted operating range.

In addition it is conceivable for a plurality of components of the power ORing to be interconnected in series in such a way that, in the event of failure of one component, a current flow into one of the energy sources 12, 14 is suppressed.

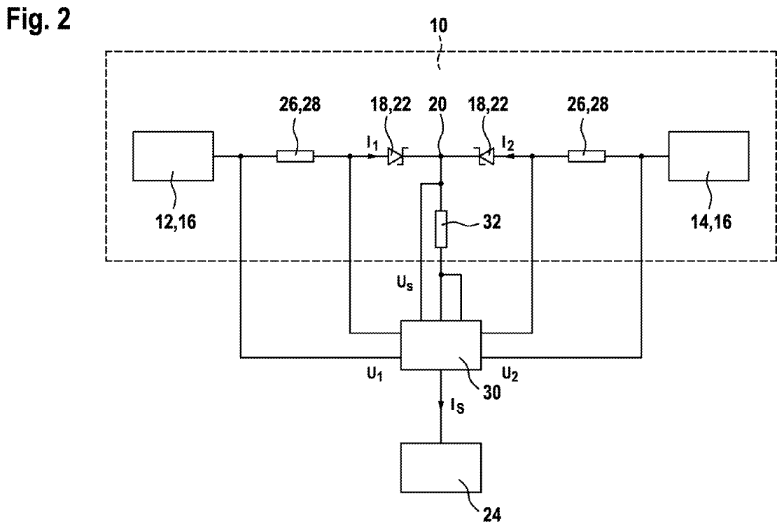

FIG. 2 shows a block circuit diagram of a second exemplary embodiment of the energy supply device 10 according to the invention. The components provided with the same reference symbols are identical to those according to FIG. 1 and will therefore not be explained again here. The substantial difference with respect to the first exemplary embodiment is a current measurement unit 32 for measuring the summation current I_{S} at the star point 20. Similarly to the current measurement units 26, the current measurement unit 32 can also be in the form of a shunt resistor 28 or another component suitable for current measurement. The current measurement unit 32 is connected to the open-loop or closed-loop control unit 30 so that a plausibility check in respect of the measured individual currents I₁, I₂ of the energy sources 12, 14 is possible by means of the measured summation current I_{S}. In addition to the currents, in the second exemplary embodiment in addition also the individual voltages U₁, U₂ of the two energy sources 12, 14 and the supply voltage Us are detected at the star point by the open-loop and closed-loop control unit 30. These can also be used for a plausibility check in respect of the measured individual currents I₁, I₂.

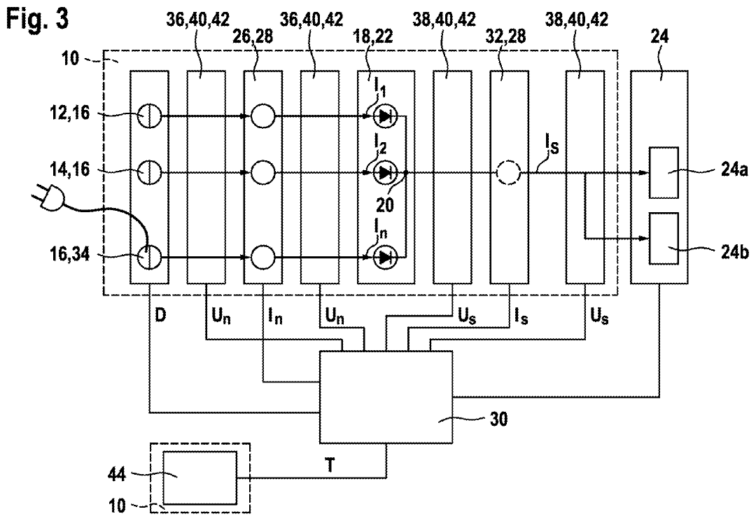

FIG. 3 shows a block circuit diagram of a third exemplary embodiment of the energy supply device 10 according to the invention. The individual components substantially correspond to those from FIGS. 1 and 2, wherein now, however, for reasons of improved clarity, the parallel-operated energy sources 12, 14 and 34 are illustrated one below the other. In this case, 34 denotes an n-th energy source, which in this case is additionally in the form of a power pack (AC/DC conversion) of a grid power supply.

All of the n energy sources 12, 14, 34 are interconnected in parallel in the sense of power ORing by means of, for example, electronic components 18 in the form of diodes 22 for ORing the individual currents I₁, I₂, . . . Iₙ at the star point 20, with the result that the individual currents I₁, I₂, . . . Iₙ of the n energy sources 12, 14, 34 downstream of the star point 20 result in the summation current I_{S} for supplying power to the electric processing tool 12 or a consumer 24 contained therein. In this case, the consumer 24 of the electric processing tool 12 can also be divided into a plurality of individual consumers 24a, 24b which are dependent on one another or independent of one another. For example, it is conceivable that the consumers 24a, 24b are a plurality of electric motors for driving a cutting bar and a gear train (separate therefrom) of a lawnmower.

Similarly to FIG. 2, the open-loop or closed-loop control unit 30 receives information on the measured individual currents I₁, I₂, . . . Iₙ of the n energy sources 12, 14, 34 and the summation current I_{S} at the star point 20 by means of the current measurement units 26 and 32. The latter can be in the form of shunt resistors 28 or other components suitable for current measurement. In addition to the current measurement units 26 and 32, the open-loop or closed-loop control unit 30 also receives specific data D from the energy sources 12, 14, 34, such as, for example, their type, their permissible operating range, temperature measured values, etc. These can be used in addition for matching the summation current I_{S}.

Furthermore, 36 and 38 denote means for detecting the individual voltages Uₙ of the energy sources 12, 14, 34 and the supply voltage U_{S} at the star point 20. The means 36, can additionally also be in the form of overvoltage protection 40 for protection from voltage peaks, such as can arise, for example, when an energy source 12, 14, 34 in the form of an interchangeable rechargeable battery pack 16 is removed during running operation of the electric processing tool. In this case, in particular TVS diodes, capacitors or other means suitable for protection from overvoltages can be used. In addition or as an alternative, the means 36, 38 can also have the function of overcurrent protection 42. Such protective circuits can be realized, for example, by fuses, MOSFETs or correspondingly suitable means for interrupting the respective current paths.

Furthermore, the energy supply device 10 has a temperature measurement device 44 for measuring a temperature T. On the basis of the measured temperature T, the open-loop or closed-loop control unit 30 can, if required, limit the summation current I_{S} in such a way that firstly the energy sources 12, 14, 34 remain in their permitted operating range and secondly the thermal limits of the energy supply device 10 are maintained. This is particularly expedient when the energy sources 12, 14, 34 themselves cannot transmit individual temperature values to the open-loop or closed-loop control unit 30 by means of the data D.

Finally, reference will be made to the fact that the invention is not restricted to the exemplary embodiments shown in the three figures. Thus it is conceivable for only a subset of energy sources, instead of all of them, to be equipped with an ammeter and/or a voltmeter. This can be expedient, for example, in the case of an electric processing tool which is supplied power via two interchangeable rechargeable battery packs 16 and in which the individual current of one of the two interchangeable rechargeable battery packs can be calculated in accordance with Kirchhoff's laws using the summation current at the star point and the measured individual current of the other interchangeable rechargeable battery pack 16.

1. An electric processing tool comprising:
an energy supply device;
a current measurement unit; and
an open-loop or closed-loop control unit,
wherein the energy supply device comprises has at least two energy sources, which are each interconnected in a series circuit with an electronic component configured to apply a logical operator “OR” to individual currents from the at least two energy sources so as to form a common star point in such a way that a resultant summation current results for supplying power to the electric processing tool,
wherein the current measurement unit is configured to measure the individual currents from the at least two energy sources, and
wherein the open-loop or closed-loop control unit is configured to match the summation current to the measured individual currents.

2. The electric processing tool as claimed in claim 1, wherein the energy supply device further comprises, at least for a subset of the at least two energy sources, a voltmeter configured to measure a voltage provided by a respective energy source included in the subset of the at least two energy sources.

3. The electric processing tool as claimed in claim 1, wherein the energy supply device further comprises a voltmeter configured to measure a supply voltage at the star point.

4. The electric processing tool as claimed in claim 1, wherein the energy supply device further comprises a current measurement unit configured to measure the summation current at the star point.

5. The electric processing tool as claimed in claim 1, wherein the energy supply device further comprises a temperature measurement device configured to measure a temperature.

6. The electric processing tool as claimed in claim 1, wherein the energy supply device further comprises at least one protective circuit configured to protect from an overvoltage.

7. The electric processing tool as claimed in claim 1, wherein the energy supply device further comprises at least one protective circuit configured to protect from an overcurrent.
